(19) United States
(12) Patent Application Publication
(10) Pub. No.: US 2025/0282947 A1
(43) Pub. Date: Sep. 11, 2025

(54) Polyester Polymer Composition Containing Low Friction Aid

(71) Applicant: Celanese Polymers Holding, Inc., Wilmington, DE (US)

(72) Inventor: Julien Cretenoud, Préverenges (CH)

(21) Appl. No.: 19/075,943

(22) Filed: Mar. 11, 2025

Related U.S. Application Data
(60) Provisional application No. 63/563,494, filed on Mar. 11, 2024.

(51) Int. Cl. C08L 67/06

(52) U.S. Cl. CPC C08L 67/06; C08L 2203/02

(57) ABSTRACT

Thermoplastic polymer compositions are disclosed, such as polyester compositions, having very low friction characteristics. The composition can be formulated to be free of reinforcing fibers, such as glass fibers. The composition can contain a silicone polymer in combination with a carrier polymer. The carrier polymer can comprise a polyolefin polymer. The composition can also contain a combination of lubricants.

### RELATED APPLICATIONS

The present application is based upon and claims priority to U.S. Provisional Patent Application Ser. No. 63/563,494, having a filing date of Mar. 11, 2024, which is incorporated herein by reference in its entirety.

### BACKGROUND

Engineering thermoplastics and elastomeric materials are often used in numerous and diverse applications in order to produce molded parts and products. For instance, polyester polymers and polyester elastomers are used to produce all different types of molded products, such as injection molded products, blow molded products, and the like. Polyester polymers, for instance, can be formulated in order to be chemically resistant, to have excellent strength properties and, when formulating compositions containing polyester elastomers, to be flexible. Of particular advantage, polyester polymers can be melt processed due to their thermoplastic nature. In addition, polyester polymers can be recycled and reprocessed.

In certain applications, polyester polymers are combined with glass fibers in order to increase the modulus and/or tensile strength of parts and products made from the reinforced composition. In other applications, however, the presence of reinforcing fibers may be problematic. For instance, glass fibers are typically coated with a sizing composition that is not well suited for producing molded parts in the medical or food handling fields. In addition, glass fibers can interfere with the flow properties of the polymer. Glass fibers also produce surface texture that can produce components and parts having a rough or non-smooth surface, which can increase the friction characteristics of the outer surface.

In view of the above, a need currently exists for a polyester polymer composition that does not contain glass fibers but possesses excellent melt processing characteristics and other physical properties. In particular, a need exists for a polyester polymer composition that displays a low coefficient of friction. A need also exists for a polyester polymer composition that can be easily molded without producing mold deposits and that can be easily ejected from molds for lowering cycle times. A need also exists for a polyester polymer composition as described above that is also well suited for use in medical applications and food handling applications.

### SUMMARY

In general, the present disclosure is directed to a thermoplastic polymer composition, particularly a polyester composition, that is suitable for use in the healthcare field and/or for food handling applications, is highly fluidic when heated, and displays a very low coefficient of friction for applications that require repeated sliding of the material.

In one aspect, for instance, the present disclosure is directed to a polymer composition containing a polyester polymer, such as a polybutylene terephthalate polymer. The polybutylene terephthalate polymer can be present alone or in combination with other polymers within the composition. The other polymers may comprise, for instance, a different polyester polymer, such as a polyethylene terephthalate polymer, a second polybutylene terephthalate polymer, or the like. In accordance with the present disclosure, the polymer composition contains a tribological modifier. The tribological modifier comprises a silicone polymer blended with a polyolefin polymer, such as a polyethylene polymer. The silicone polymer can comprise an ultrahigh molecular weight silicone polymer. The ultrahigh molecular weight silicone polymer, for instance, can have a kinematic viscosity of greater than about 100,000 mm²s⁻¹. The silicone polymer can be preblended with the polyethylene polymer and can comprise a masterbatch that is incorporated into the polymer composition. The weight ratio between the silicone polymer and the polyethylene polymer within the tribological modifier can be from about 3:1 to about 1:3, such as from about 1.5:1 to about 1:1.5. The tribological modifier can be present in the polymer composition in an amount from about 0.1% by weight to about 10% by weight, such as in an amount from about 0.5% by weight to about 8% by weight, such as in an amount from about 3.5% by weight to about 7.5% by weight.

The polymer composition can be free of glass fibers or any other reinforcing fibers. The polymer composition can contain one or more polyester polymers, such as the polybutylene terephthalate polymer in an amount greater than about 70% by weight, such as in an amount greater than about 75% by weight, such as in an amount greater than about 80% by weight, such as in an amount greater than about 85% by weight, such as in an amount greater than about 90% by weight, and in an amount less than about 98% by weight, such as in an amount less than about 95% by weight. The polybutylene terephthalate polymer can have a relatively high melt flow rate. For instance, the melt flow rate of the polybutylene terephthalate polymer can be greater than about 30 g/10 min, such as greater than about 35 g/10 min, such as greater than about 38 g/10 min, and less than about 100 g/10 min, such as less than about 80 g/10 min, such as less than about 60 g/10 min, such as less than about 50 g/10 min.

The polymer composition can further contain at least one lubricant. In one aspect, for instance, the polymer composition can contain a single lubricant comprising a polar polymer. Alternatively, the polymer composition can contain a first lubricant and a second lubricant. The first lubricant can be a polar polymer, while the second lubricant can be a non-polar polymer or vice versus. The first lubricant and the second lubricant can be present in the polymer composition at a weight ratio of from about 10:1 to about 1:10, such as from about 5:1 to about 1:5, such as from about 3:1 to about 1:3, such as from about 1.5:1 to about 1:1.5.

In one embodiment, all of the lubricants present in the polymer composition can be approved for food handling and/or medical applications. The polar polymer that comprises the first lubricant, for instance, can be a polyolefin polymer, such as a polyethylene polymer. In one embodiment, for instance, the polar polymer can be an oxidized polyethylene wax.

The non-polar polymer that comprises the second lubricant, on the other hand, can also be a polyolefin polymer. For instance, the non-polar polymer can be a polyethylene wax.

In one aspect, the polymer composition can be formulated so as to contain only a single lubricant, such as a polar lubricant. The polar lubricant, for instance, can have an acid value of generally greater than about 5 KOH/g, such as greater than about 10 KOH/g, such as greater than about 15 KOH/g, and generally less than about 90 KOH/g, such as less than about 70 KOH/g, such as less than about 60 KOH/g. The acid value of the polar lubricant, for instance, can be selected based upon the particular application and the components contained in the polymer composition. In one embodiment, for instance, the acid value of the polar lubricant can be from about 13 KOH/g to about 23 KOH/g, such as from about 15 KOH/g to about 19 KOH/g. Alternatively, the polar lubricant can have a higher acid value. For example, in an alternative embodiment, the polar lubricant can have an acid value of from about 40 KOH/g to about 60 KOH/g, such as from about 45 KOH/g to about 55 KOH/g.

As described above, the polar lubricant can comprise an oxidized wax. For example, the polar lubricant can be an oxidized polyethylene wax. Alternatively, the polar lubricant can be oxidized esters of fatty acids. The oxidized esters of fatty acids, for instance, can be derived from biomass, such as rice bran. In one aspect, the oxidized esters of fatty acids can be derived from a blend of different fatty acids with different carbon chain lengths. In one aspect, for instance, the oxidized esters of fatty acids can be derived from greater than 50% by weight of fatty acids having a carbon chain length of from about 20 carbon atoms to about 40 carbon atoms. The oxidized esters of fatty acids can also be derived from a blend of fatty acids in which 25% by weight of the fatty acids or greater are derived from fatty acids having a carbon chain length of from about 40 carbon atoms to about 64 carbon atoms.

Each lubricant contained in the polymer composition can generally be present in the composition in an amount less than about 2% by weight, such as in an amount less than about 1% by weight, such as in an amount less than about 0.8% by weight, such as in an amount less than about 0.5% by weight, such as in an amount less than about 0.4% by weight. Each lubricant is generally present in the polymer composition in an amount greater than about 0.01% by weight, such as in an amount greater than about 0.08% by weight.

The one or more lubricants serve to minimize mold deposits and can also reduce the force needed to remove a molded part from the mold.

The polymer composition can also contain a nucleating agent. The nucleating agent, for instance, can comprise a mineral nucleant. For instance, in one embodiment, the nucleating agent can comprise talc particles. The nucleating agent can be present in the polymer composition in an amount less than about 1.5% by weight, such as in an amount less than about 1% by weight, such as in an amount less than about 0.8% by weight, such as in an amount less than about 0.6% by weight, such as in an amount less than about 0.4% by weight, such as in an amount less than about 0.3% by weight. The nucleating agent can be present in the polymer composition in an amount greater than about 0.001% by weight, such as in an amount greater than about 0.05% by weight, such as in an amount greater than about 0.08% by weight.

As described above, the polymer composition can be formulated to have low friction properties. For instance, the polymer composition can exhibit a dynamic coefficient of friction according to VDA 230-206 of less than about 0.08 when tested against polycarbonate containing 15% by weight polytetrafluoroethylene and 20% by weight glass fiber or when tested against polybutylene terephthalate containing 15% by weight polytetrafluoroethylene and 20% by weight glass fiber, or when tested against itself at a speed of 8 mm/s, at a load of 30 N and after 1,000 cycles. In one embodiment, the polymer composition may exhibit a dynamic coefficient of friction of less than about 0.07, such as less than about 0.05 when tested against the above materials.

The present disclosure is also directed to molded articles made from the polymer composition. The molded articles can comprise a medical device and/or a food handling device. The molded article, for instance, can comprise an inhaler, an injection device, a surgical instrument, or a wearable device. In one embodiment, the polymer composition of the present disclosure can be used to produce at least one molded article or component on an injector. The injector can be for dispensing liquid medicaments. The injector can include a needle that has a bore size of from about 0.08 mm to about 0.25 mm. The injector can include a spring member that dispenses doses of a medicament at a maximum force of greater than about 3 N.

In one aspect, the molded article of the present disclosure can be incorporated into a medical device and can comprise a sliding member. In one embodiment, the polymer composition can be used to produce an assembly including a first sliding member and a second sliding member. The first sliding member and the second sliding member may be positioned to remain in contact and move relative to each other.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of a medical inhaler made in accordance with the present disclosure; and

FIG. 2 is a side view of a medical injector that may be made in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a thermoplastic polymer composition having excellent flow properties in combination with low friction characteristics. Of particular advantage, the polymer composition of the present disclosure can be formulated for use in the healthcare industry and/or the food handling industry. Due to the low friction characteristics, the polymer composition is particularly well suited for producing molded articles and components that require repeated sliding. The polymer composition of the present disclosure, for instance, is well suited to producing medical injection devices, such as insulin auto-injector pens, lipstick mechanisms, mascara stems, medical inhalers, and the like. In one aspect, the polymer composition contains primarily a polybutylene terephthalate polymer which does not emit any vapors or off gases during molding and during use and is biocompatible.

In addition to a polyester polymer, such as a polybutylene terephthalate polymer, the polymer composition in accordance with the present disclosure includes at least one tribological modifier and optionally a nucleating agent and/or one or more lubricants. The tribological modifier in accordance with the present disclosure can comprise a masterbatch of a silicone polymer blended with a polyolefin polymer, such as a polyethylene polymer. The polyethylene polymer was found to synergistically combine with the silicone polymer to dramatically reduce the friction characteristics of articles molded from the polymer composition. Although unknown, it is believed that the polyethylene polymer provides for better dispersion of the silicone polymer within the polyester matrix. Although unknown, it is believed that the polyethylene polymer facilitates migration of the silicone polymer to the surface for reducing friction properties.

As described above, the polymer composition can also contain a nucleating agent that helps crystallize the polybutylene terephthalate polymer. In this manner, the nucleating agent can facilitate demolding of molded articles made in accordance with the present disclosure while decreasing cycle times. In one aspect, the nucleating agent can be used with a relatively low molecular weight polybutylene terephthalate having a relatively high melt flow rate.

As described above, the polymer composition of the present disclosure can be formulated for use in medical and food handling applications. In this regard, the polymer composition of the present disclosure can be formulated so that every component contained in the composition meets governmental regulations regarding food handling or medical applications. For example, every component contained in the polymer composition can be approved for use according to the United States Food and Drug Administration food contact standards and approved listings as found in Title 21 of the Code of Federal Regulations (as in existence in March of 2021). For example, each polymer contained within the polymer composition can be approved for food handling applications as indicated in 21 CFR 177. Each component contained in the polymer composition can also be approved for food handling applications according to 21 CFR 174.

Each component contained within the polymer composition can also meet or exceed all food contact standards such as Regulation (EC) No. 1935/2004, 2023/2006, 10/2011, Resolution AP (89) 1, Germany BfR IX, Spain Real Decreto 847/2011, and Italy Decreto 21/3/73; and Chinese food contact standards such as GB 9685-2016.

The composition of the present disclosure can be formulated for medical applications that require low friction properties. For example, when used in medical applications, the polymer composition can contain no isocyanates, epoxy resins, carbodiimides or other similar compounds. In certain applications, medical devices are needed in which the parts are not only made from high strength materials but that can provide ultra-low friction and reduced wear for parts that are intended to slide against an adjacent surface. As will be described in greater detail below, polymer compositions made according to the present disclosure have not only excellent strength properties but can display extremely low friction properties.

When two opposing surfaces slide against each other, the surfaces react in a way that is referred to as the stick-slip phenomenon. The stick-slip phenomenon refers to the manner in which two opposing surfaces or articles slide over each other in reaction to the forces of friction. Static friction refers to the friction between two or more objects that are not moving relative to each other. Kinetic friction, on the other hand, occurs when two objects are moving relative to each other while remaining in contact. In order for one object to slide relative to another object, enough force must be exerted on one object to overcome the forces of static friction. When movement between the two objects occurs, a reduction of the friction between the two surfaces can cause a sudden increase in the velocity of movement. In other words, once one object moves relative to another object, in some applications, less force is needed to continue movement. The friction between the two surfaces can increase or decrease during movement depending upon numerous factors, including the speed at which movement continues. Stick-slip describes how surfaces alternate between sticking to each other and sliding over each other as movement occurs between two surfaces and as the conditions of movement change.

Polymer articles that have a relatively high coefficient of friction not only require greater amounts of force in order to slide one material over the other but also can be prone to wear. Over time, for instance, the materials can begin to degrade due to the forces of friction.

In one aspect, the polymer composition of the present disclosure can optionally contain one or more tribological modifiers for producing molded articles having low friction characteristics. The molded articles are particularly well suited for use in medical and/or food handling applications. For example, in one embodiment, the present disclosure is directed to a low friction assembly that includes a first sliding member in operative association with a second sliding member. The first sliding member and the second sliding member can both be made from a polymer composition formulated in accordance with the present disclosure. When tested against each other or against a polycarbonate/ABS blend (CYCOLOY C1204H from Sabic), the composition can be formulated so as to exhibit a dynamic coefficient of friction of less than about 0.08, such as less than about 0.07, such as less than about 0.06, such as less than about 0.05. The compositions or molded parts can be tested against each other according to a stick-slip test having Test No. VDA 230-206.

Specimens tested using the above method can also be analyzed to measure a wear track width which is an abrasion width. In accordance with the present disclosure, the compositions and molded articles can exhibit a wear track width of less than 0.3 mm, such as less than about 0.25 mm, such as even less than about 0.2 mm when tested at a force of 30 N and at a velocity of 8 mm/s after 1,000 cycles.

### Polyester Polymer

In one embodiment, the thermoplastic matrix polymer contained in the polymer composition comprises one or more polyester polymers. The polyester polymer generally comprises a polyalkylene terephthalate polymer.

Polyalkylene terephthalate polymers suitable for use herein are derived from an aliphatic or cycloaliphatic diol, or mixtures thereof, containing from 2 to about 10 carbon atoms and an aromatic dicarboxylic acid.

The polyesters which are derived from a cycloaliphatic diol and an aromatic dicarboxylic acid are prepared by condensing either the cis- or trans-isomer (or mixtures thereof) of, for example, 1,4-cyclohexanedimethanol with the aromatic dicarboxylic acid.

Examples of aromatic dicarboxylic acids include isophthalic or terephthalic acid, 1,2-di(p-carboxyphenyl) ethane, 4,4′-dicarboxydiphenyl ether, etc., and mixtures of these. All of these acids contain at least one aromatic nucleus. Fused rings can also be present such as in 1,4- or 1,5- or 2,6-naphthalene-dicarboxylic acids. In one embodiment, the dicarboxylic acid is terephthalic acid or mixtures of terephthalic and isophthalic acid.

In one embodiment, the polyalkylene terephthalate polymer present in the polymer composition comprises a polybutylene terephthalate polymer. For example, the polymer composition may contain a polybutylene terephthalate polymer in an amount greater than about 50% by weight, such as in an amount greater than about 70% by weight, such as in an amount greater than about 75% by weight, such as in an amount greater than about 80% by weight, such as in an amount greater than about 85% by weight. The polybutylene terephthalate polymer is generally present in an amount less than about 98% by weight, such as in an amount less than about 95% by weight.

The polybutylene terephthalate polymer present in the polymer composition can have a relatively low molecular weight and a relatively high melt flow rate. The melt flow rate can be measured according to ISO Test 1133 at a temperature of 250° C. and at a load of 2.16 kg. The melt flow rate of the polybutylene terephthalate polymer can be greater than about 25 g/10 min, such as greater than about 30 g/10 min, such as greater than about 33 g/10 min, such as greater than about 35 g/10 min, such as greater than about 38 g/10 min, and less than about 100 g/10 min, such as less than about 80 g/10 min, such as less than about 60 g/10 min, such as less than about 50 g/10 min, such as less than about 45 g/10 min.

The polymer composition may contain the polybutylene terephthalate polymer alone or in combination with other thermoplastic polymers. For instance, the polybutylene terephthalate polymer may be combined with other polyester polymers. Other polyester polymers that may be present in the composition include a polyethylene terephthalate polymer or a polyethylene terephthalate copolymer. For instance, a polyethylene terephthalate copolymer or modified polyethylene terephthalate polymer can be produced with a modifying acid or a modifying diol.

As used herein, the terms “modifying acid” and “modifying diol” are meant to define compounds, which can form part of the acid and diol repeat units of a polyester, respectively, and which can modify a polyester to reduce its crystallinity or render the polyester amorphous. In one embodiment, however, the polyesters present in the polymer composition of the present disclosure are non-modified and do not contain a modifying acid or a modifying diol.

Examples of modifying acid components may include, but are not limited to, isophthalic acid, phthalic acid, 1,3-cyclohexanedicarboxylic acid, 1,4-cyclohexane dicarboxylic acid, 2,6-naphthaline dicarboxylic acid, succinic acid, glutaric acid, adipic acid, sebacic acid, suberic acid, 1,12-dodecanedioic acid, and the like. In practice, it is often preferable to use a functional acid derivative thereof such as the dimethyl, diethyl, or dipropyl ester of the dicarboxylic acid. The anhydrides or acid halides of these acids also may be employed where practical. Preferred is isophthalic acid.

Examples of modifying diol components may include, but are not limited to, neopentyl glycol, 1,4-cyclohexanedimethanol, 1,2-propanediol, 1,3-propanediol, 2-Methy-1,3-propanediol, 1,4-butanediol, 1,6-hexanediol, 1,2-cyclohexanediol, 1,4-cyclohexanediol, 1,2-cyclohexanedimethanol, 1,3-cyclohexanedimethanol, 2,2,4,4-tetramethyl 1,3-cyclobutane diol, Z,8-bis(hydroxymethyltricyclo-[5.2.1.0]-decane wherein Z represents 3, 4, or 5; 1,4-Bis(2-hydroxyethoxy)benzene, 4,4′-Bis(2-hydroxyethoxy) diphenylether [Bis-hydroxyethyl Bisphenol A], 4,4′-Bis(2-hydroxyethoxy)diphenylsulfide [Bis-hydroxyethyl Bisphenol S] and diols containing one or more oxygen atoms in the chain, e.g. diethylene glycol, triethylene glycol, dipropylene glycol, tripropylene glycol, and the like. In general, these diols contain 2 to 18, preferably 2 to 8 carbon atoms. Cycloalphatic diols can be employed in their cis or trans configuration or as mixtures of both forms.

When present, the polyester polymer combined with the polybutylene terephthalate can be added to the polymer composition in amounts generally greater than about 1% by weight, such as in amounts greater than about 2% by weight, such as in amounts greater than about 3% by weight. The polyester polymer is generally present in an amount less than about 20% by weight, such as in an amount less than about 15% by weight, such as in an amount less than about 10% by weight, such as in an amount less than about 5% by weight.

### Tribological Modifier

According to the present disclosure, the polymer composition and the polymer article comprising the reinforced polymer composition may comprise at least one tribological modifier.

In one embodiment, ultra-high molecular weight silicone (UHMW-Si) may be used to modify the thermoplastic polymer. In general, the UHMW-Si can have an average molecular weight of greater than 100,000 g/mol, such as greater than about 200,000 g/mol, such as greater than about 300,000 g/mol, such as greater than about 500,000 g/mol and less than about 3,000,000 g/mol, such as less than about 2,000,000 g/mol, such as less than about 1,000,000 g/mol, such as less than about 500,000 g/mol, such as less than about 300,000 g/mol. Generally, the UHMW-Si can have a kinematic viscosity at 40° C. measured according to DIN 51562 of greater than 100,000 mm²s⁻¹, such as greater than about 200,000 mm²s⁻¹, such as greater than about 1,000,000 mm²s⁻¹, such as greater than about 5,000,000 mm²s⁻¹, such as greater than about 10,000,000 mm²s⁻¹, such as greater than about 15,000,000 mm²s⁻¹ and less than about 50,000,000 mm²s⁻¹, such as less than about 25,000,000 mm²s⁻¹, such as less than about 10,000,000 mm²s⁻¹, such as less than about 1,000,000 mm²s⁻¹, such as less than about 500,000 mm²s⁻¹, such as less than about 200,000 mm²s⁻¹.

The UHMW-Silicone may comprise a siloxane such as a polysiloxane or polyorganosiloxane. In one embodiment, the UHMW-Si may comprise a dialkylpolysiloxane such as a dimethylsiloxane, an alkylarylsiloxane such as a phenylmethylsiloxane, a polysilsesquioxane, or a diarylsiloxane such as a diphenylsiloxane, or a homopolymer thereof such as a polydimethylsiloxane or a polymethylphenylsiloxane, or a copolymer thereof with the above molecular weight and/or kinematic viscosity requirements. The polysiloxane or polyorganosiloxane may also be modified with a substituent such as an epoxy group, a hydroxyl group, a carboxyl group, an amino group or a substituted amino group, an ether group, or a meth(acryloyl) group in the end or main chain of the molecule. The UHMW-Si compounds may be used singly or in combination. Any of the above UHMW-Si compounds may be used with the above molecular weight and/or kinematic viscosity requirements.

The UHMW-Silicone may be added to the polymer composition as a masterbatch wherein the UHMW-Si is dispersed in a carrier polymer and the masterbatch is thereafter added to the composition. The masterbatch may comprise from about 10 wt. % to about 70 wt. %, such as from about 35 wt. % to about 55 wt. %, such as about 50 wt. % of an UHMW-Si. The carrier polymer, on the other hand, can be present in the masterbatch in an amount from about 90% by weight to about 30% by weight, such as in an amount from about 45% by weight to about 65% by weight.

The carrier polymer can vary depending upon the particular application and the desired result. The carrier polymer, for instance, can comprise a polyester polymer such as polybutylene terephthalate, a copolyester polymer, or a polyolefin polymer, such as a polyethylene polymer. It was discovered, however, that the use of a polyolefin polymer, particularly a polyethylene polymer, can provide numerous advantages and benefits. It is believed that the use of a polyethylene carrier polymer acts synergistically with the silicone polymer when contained in a polyester polymer composition that does not contain glass fibers. The polyolefin or polyethylene carrier polymer, for instance, can provide a soft and silky finish to articles molded from the polymer composition. The silicone polymer master batch lowers the friction coefficient of the material. The use of the polyethylene carrier polymer, however, is believed to provide good dispersion in the polyester matrix and facilitates migration of the silicone polymer to the surface of the molded article. Overall, the carrier polymer improves the wear resistance of the material while also improving the coefficient of friction.

The UHMW-Silicone may be present in the polymer composition in an amount of at greater than about 0.005 wt. %, such as at greater than about 0.1 wt. %, such as at greater than about 0.5 wt. %, such as at greater than about 0.75 wt. %, such as at greater than about 1 wt. %, such as at greater than about 2 wt. %, such as at greater than about 2.5 wt. % and generally less than about 10 wt. %, such as less than about 6 wt. %, such as less than about 5 wt. %, such as less than about 4 wt. %, such as less than about 3.5 wt. %, such as less than about 3 wt. %, wherein the weight is based on the total weight of the polymer composition.

### Lubricant

In accordance with the present disclosure, the polymer composition contains one or more lubricants that are added to lower ejection forces of parts from a mold, such as a mold during injection molding. Alternatively, the one or more lubricants can be added in an amount sufficient to lower mold deposits, in comparison to an identical composition not containing the one or more lubricants.

In one aspect, the one or more lubricants can be present in the polymer composition alone or in combination with a nucleant can improve the melt processing behavior or properties of the polymer composition. The mold release package of the present disclosure, for instance, can increase crystallization rates and melt-solidification rates. Polymer compositions incorporating the mold release package can also form a more stable melt that can significantly improve cycle times and increase production.

In one aspect, the polymer composition only contains a single lubricant. The lubricant, for instance, can be a polar lubricant and/or an oxidized lubricant. Polar materials, for instance, blend well with the other components. The polar polymers for use in the present disclosure have been found to dramatically reduce mold deposits due to their interactions with the other components during molding. The polar lubricant, for instance, can be an oxidized wax, such as an oxidized polyolefin wax or oxidized esters of carboxylic acids. The oxidized polyolefin wax, for instance, can be an oxidized polyethylene wax.

The polarity of the lubricant can vary depending upon the particular application and the desired result. The polarity, for instance, can be indicated by the acid value of the lubricant. The acid value of the polar lubricant, for instance, can generally be greater than about 10 KOH/g, such as greater than about 15 KOH/g, such as greater than about 20 KOH/g, such as greater than about 25 KOH/g, such as greater than about 30 KOH/g, such as greater than about 35 KOH/g, such as greater than about 40 KOH/g, such as greater than about 45 KOH/g, such as greater than about 50 KOH/g. The acid value is generally less than about 95 KOH/g, such as less than about 90 KOH/g, such as less than about 85 KOH/g, such as less than about 80 KOH/g, such as less than about 75 KOH/g, such as less than about 70 KOH/g.

In one aspect, the acid value of the polar lubricant can be from about 13 KOH/g to about 23 KOH/g, such as from about 15 KOH/g to about 19 KOH/g. In an alternative embodiment, the acid value of the polar lubricant can be from about 40 KOH/g to about 65 KOH/g, such as from about 45 KOH/g to about 55 KOH/g.

As described above, in one embodiment, the polar lubricant can be oxidized esters of carboxylic acids. In one aspect, the oxidized esters of carboxylic acids can be derived from biomass materials, such as rice bran.

The different carboxylic acids used to produce the oxidized esters of fatty acids can vary depending upon the source of the fatty acids and the desired result. In one embodiment, the oxidized esters of fatty acids can be derived from at least three different fatty acids, such as at least five different fatty acids, such as at least about eight different fatty acids, and generally less than about 20 different fatty acids, such as less than about 15 different fatty acids. The fatty acids used to produce the oxidized esters, for instance, can have various different chain lengths. For instance, of all the fatty acids present in the oxidized wax, greater than about 20% by weight, such as greater than about 30% by weight, such as greater than about 40% by weight, such as greater than about 50% by weight, such as greater than about 60% by weight, can be derived from fatty acids having a carbon chain length of from about 20 carbon atoms to about 40 carbon atoms. The oxidized wax can also be derived from longer chain fatty acids. For instance, the oxidized wax can be derived from greater than about 5% by weight, such as greater than about 10% by weight, such as greater than about 15% by weight, such as greater than about 20% by weight, such as greater than about 25% by weight, such as greater than about 30% by weight, such as greater than about 40% by weight, such as greater than about 45% by weight, such as greater than about 50% by weight of fatty acids having a carbon chain length of from about 40 carbon atoms to about 64 carbon atoms. The above carboxylic acids can be aliphatic carboxylic acids. In one aspect, the oxidized wax contains less than about 5% by weight of esters derived from fatty acids having a carbon chain length of less than about 14 carbon atoms, such as less than about 12 carbon atoms, such as less than about 10 carbon atoms, such as less than about 8 carbon atoms.

In one particular embodiment, the polymer composition contains a first lubricant and a second lubricant that are both completely safe for food handling applications and/or medical applications. The first lubricant, for instance, can be a polar polymer.

Various different polar materials may be used as the first lubricant, including the polar polymers described above. The polar polymer, for instance, can be a polyolefin polymer, particularly a modified polyolefin polymer. The polar, polyolefin polymer, for instance, can be a polyethylene polymer or a polypropylene polymer, including copolymers thereof. In one particular embodiment, the first lubricant can be an oxidized polyethylene wax.

Other polar waxes can be polar-modified polymers of ethylene and/or propylene formed using, for example, metallocene catalysts. Examples that can be mentioned include homopolymers or copolymers of ethylene and/or propylene modified in the presence of hydrophilic groups such as maleic anhydride, acrylate, methacrylate, or polyvinylpyrrolidone (PVP) groups. Examples include maleic anhydride modified polypropylene polymers (PPMA), or maleic anhydride polypropylene and ethylene copolymers. In one aspect, the polar wax can be derived from rice bran as described above.

In addition to polar materials, effective lubricants can also comprise non-polar materials, such as non-polar polymers. Non-polar polymers, for example, can migrate to the surface of polymer articles made from the polymer composition during molding. In this manner, non-polar polymer materials in accordance with the present disclosure can significantly reduce the amount of force needed in order to eject a part from a mold. Non-polar polymers that may be used in accordance with the present disclosure include various different non-polar polyolefin polymers, including polyethylene polymers and polypropylene polymers. The polyolefin polymer can be a homopolymer or a copolymer. In one embodiment, the non-polar polymer can be a polyethylene wax.

In one particular embodiment, the polymer composition contains a first lubricant comprising a polar polymer in combination with a second lubricant comprising a non-polar polymer.

Each lubricant can be present in the polymer composition generally in an amount less than about 2% by weight, such as in an amount less than about 1% by weight, such as in an amount less than about 0.8% by weight, such as in an amount less than about 0.6% by weight, such as in an amount less than about 0.4% by weight, such as in an amount less than about 0.2% by weight. The one or more lubricants are generally present in the polymer composition in an amount greater than about 0.01% by weight.

When the polymer composition contains a first lubricant in combination with a second lubricant as described above, the weight ratio between the first lubricant and the second lubricant can be from about 10:1 to about 1:10, such as from about 5:1 to about 1:5, such as from about 2:1 to about 1:2.

### Nucleant

The polymer composition of the present disclosure can contain various other additives. For example, the composition may further include a nucleant or nucleating agent present in a concentration of between about 0.1 and 2% by weight, preferably between about 0.001% and 0.5% based on the total weight of the composition. The nucleant can be selected from the group consisting of alkali metal salts having anions which are oxides of the elements from Group IV of the Periodic Table; barium sulfate; and talc.

### Other Additives

Other additives may be present in the polymer composition. The other additives can include, for instance, an antioxidant, a light stabilizer, a thermal stabilizer, reinforcing fibers, or other tribological modifiers, such as polytetrafluoroethylene particles. In one embodiment, however, all of the above additives may be completely absent from the polymer composition. For instance, in one aspect, the polymer composition is completely free of reinforcing fibers, such as glass fibers. The composition can also be fluorine-free and not contain any polytetrafluoroethylene particles. In still another embodiment, the polymer composition can be free of antioxidants, including hindered phenolic antioxidants.

Alternatively, various additives can be included into the polymer composition. For instance, sterically hindered phenolic antioxidant(s) may be employed in the composition. Examples of such phenolic antioxidants include, for instance, calcium bis(ethyl 3,5-di-tert-butyl-4-hydroxybenzylphosphonate) (Irganox® 1425); terephthalic acid, 1,4-dithio-,S,S-bis(4-tert-butyl-3-hydroxy-2,6-dimethylbenzyl) ester (Cyanox® 1729); triethylene glycol bis(3-tert-butyl-4-hydroxy-5-methylhydrocinnamate); hexamethylene bis(3,5-di-tert-butyl-4-hydroxyhydrocinnamate (Irganox® 259); 1,2-bis(3,5,di-tert-butyl-4-hydroxyhydrocinnamoyl)hydrazide (Irganox® 1024); 4,4′-di-tert-octyldiphenamine (Naugalube® 438R); phosphonic acid, (3,5-di-tert-butyl-4-hydroxybenzyl)-, dioctadecyl ester (Irganox® 1093); 1,3,5-trimethyl-2,4,6-tris(3′,5′-di-tert-butyl-4′ hydroxybenzyl)benzene (Irganox® 1330); 2,4-bis(octylthio)-6-(4-hydroxy-3,5-di-tert-butylanilino)-1,3,5-triazine (Irganox® 565); isooctyl 3-(3,5-di-tert-butyl-4-hydroxyphenyl)propionate (Irganox® 1135); octadecyl 3-(3,5-di-tert-butyl-4-hydroxyphenyl)propionate (Irganox® 1076); 3,7-bis(1,1,3,3-tetramethylbutyl)-10H-phenothiazine (Irganox® LO 3); 2,2′-methylenebis(4-methyl-6-tert-butylphenol)monoacrylate (Irganox® 3052); 2-tert-butyl-6-[1-(3-tert-butyl-2-hydroxy-5-methylphenyl)ethyl]-4-methylphenyl acrylate (Sumilizer® TM 4039); 2-[1-(2-hydroxy-3,5-di-tert-pentylphenyl)ethyl]-4,6-di-tert-pentylphenyl acrylate (Sumilizer® GS); 1,3-dihydro-2H-Benzimidazole (Sumilizer® MB); 2-methyl-4,6-bis[(octylthio)methyl]phenol (Irganox® 1520); N,N′-trimethylenebis-[3-(3,5-di-tert-butyl-4-hydroxyphenyl)propionamide (Irganox® 1019); 4-n-octadecyloxy-2,6-diphenylphenol (Irganox® 1063); 2,2′-ethylidenebis[4,6-di-tert-butylphenol] (Irganox® 129); N N′-hexamethylenebis(3,5-di-tert-butyl-4-hydroxyhydrocinnamamide) (Irganox® 1098); diethyl (3,5-di-tert-butyl-4-hydroxybenxyl)phosphonate (Irganox® 1222); 4,4′-di-tert-octyldiphenylamine (Irganox® 5057); N-phenyl-1-napthalenamine (Irganox® L 05); tris[2-tert-butyl-4-(3-ter-butyl-4-hydroxy-6-methylphenylthio)-5-methyl phenyl]phosphite (Hostanox® OSP 1); zinc dinonyidithiocarbamate (Hostanox® VP-ZNCS 1); 3,9-bis[1,1-diimethyl-2-[(3-tert-butyl-4-hydroxy-5-methylphenyl)propionyloxy]ethyl]-2,4,8,10-tetraoxaspiro[5.5]undecane (Sumilizer® AG80); pentaerythrityl tetrakis[3-(3,5-di-tert-butyl-4-hydroxyphenyl)propionate] (Irganox® 1010); ethylene-bis(oxyethylene) bis[3-(5-tert-butyl-4-hydroxy-m-tolyl)-propionate (Irganox® 245); 3,5-di-tert-butyl-4-hydroxytoluene (Lowinox BHT, Chemtura) and so forth.

Some examples of suitable sterically hindered phenolic antioxidants for use in the present composition are triazine antioxidants having the following general formula:

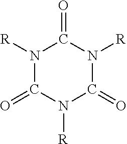

wherein, each R is independently a phenolic group, which may be attached to the triazine ring via a C₁ to C₅ alkyl or an ester substituent. Preferably, each R is one of the following formula (I)-(III):

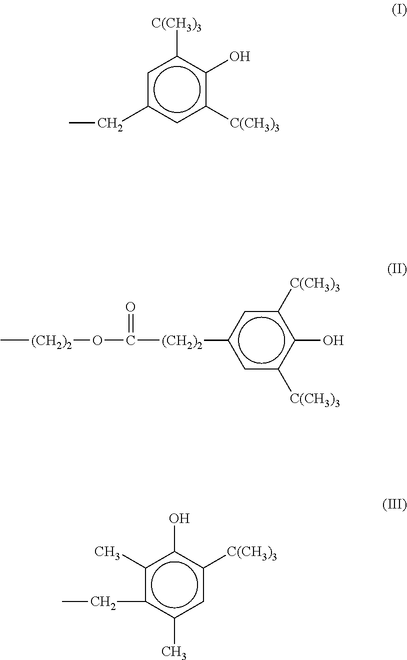

Commercially available examples of such triazine-based antioxidants may be obtained from American Cyanamid under the designation Cyanox® 1790 (wherein each R group is represented by the Formula III) and from Ciba Specialty Chemicals under the designations Irganox® 3114 (wherein each R group is represented by the Formula I) and Irganox® 3125 (wherein each R group is represented by the Formula II).

Sterically hindered phenolic antioxidants may constitute from about 0.01 wt. % to about 3 wt. %, in some embodiments from about 0.05 wt. % to about 1 wt. %, and in some embodiments, from about 0.05 wt. % to about 0.1 wt. % of the entire stabilized polymer composition. In one embodiment, for instance, the antioxidant comprises pentaerythrityl tetrakis[3-(3,5-di-tert-butyl-4-hydroxyphenyl)propionate.

Hindered amine light stabilizers (“HALS”) may be employed in the composition to inhibit degradation of the polymer composition and thus extend its durability. Suitable HALS compounds may be derived from a substituted piperidine, such as alkyl-substituted piperidyl, piperidinyl, piperazinone, alkoxypiperidinyl compounds, and so forth. For example, the hindered amine may be derived from a 2,2,6,6-tetraalkylpiperidinyl. Regardless of the compound from which it is derived, the hindered amine is typically an oligomeric or polymeric compound having a number average molecular weight of about 1,000 or more, in some embodiments from about 1000 to about 20,000, in some embodiments from about 1500 to about 15,000, and in some embodiments, from about 2000 to about 5000. Such compounds typically contain at least one 2,2,6,6-tetraalkylpiperidinyl group (e.g., 1 to 4) per polymer repeating unit.

Without intending to be limited by theory, it is believed that high molecular weight hindered amines are relatively thermostable and thus able to inhibit light degradation even after being subjected to extrusion conditions. One particularly suitable high molecular weight hindered amine has the following general structure:

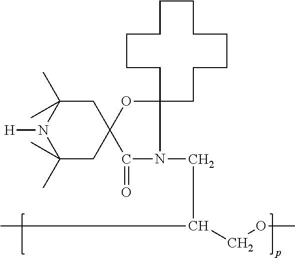

wherein, p is 4 to 30, in some embodiments 4 to 20, and in some embodiments 4 to 10. This oligomeric compound is commercially available from Clariant under the designation Hostavin® N30 and has a number average molecular weight of 1200.

Another suitable high molecular weight hindered amine has the following structure:

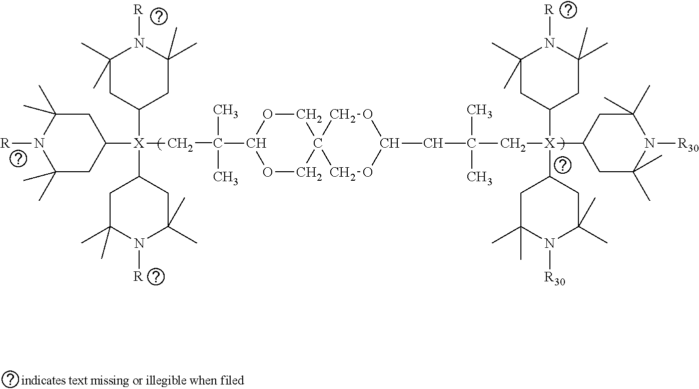

wherein, n is from 1 to 4 and R₃₀ is independently hydrogen or CHs. Such oligomeric compounds are commercially available from Adeka Palmarole SAS (joint venture between Adeka Corp. and Palmarole Group) under the designation ADK STAB® LA-63 (R₃₀ is CH₃) and ADK STAB® LA-68 (R₃₀ is hydrogen).

Other examples of suitable high molecular weight hindered amines include, for instance, an oligomer of N-(2-hydroxyethyl)-2,2,6,6-tetramethyl-4-piperidinol and succinic acid (Tinuvin® 622 from Ciba Specialty Chemicals, MW=4000); oligomer of cyanuric acid and N,N-di(2,2,6,6-tetramethyl-4-piperidyl)-hexamethylene diamine; poly((6-morpholine-S-triazine-2,4-diyl) (2,2,6,6-tetramethyl-4-piperidinyl)-iminohexamethylene-(2,2,6,6-tetramethyl-4-piperidinyl)-imino) (Cyasorb® UV 3346 from Cytec, MW=1600); polymethylpropyl-3-oxy-[4 (2,2,6,6-tetramethyl)-piperidinylysiloxane (Uvasil® 299 from Great Lakes Chemical, MW=1100 to 2500); copolymer of a-methylstyrene-N-(2,2,6,6-tetramethyl-4-piperidinyl) maleimide and N-stearyl maleimide; 2,4,8,10-tetraoxaspiro[5.5]undecane-3,9-diethanol tetramethyl-polymer with 1,2,3,4-butanetetracarboxylic acid; and so forth. Still other suitable high molecular weight hindered amines are described in U.S. Pat. No. 5,679,733 to Malik, et al. and 6,414,155 to Sassi, et al., which are incorporated herein in their entirety by reference thereto for all purposes.

In addition to the high molecular hindered amines, low molecular weight hindered amines may also be employed in the composition. Such hindered amines are generally monomeric in nature and have a molecular weight of about 1000 or less, in some embodiments from about 155 to about 800, and in some embodiments, from about 300 to about 800.

Specific examples of such low molecular weight hindered amines may include, for instance, bis-(2,2,6,6-tetramethyl-4-piperidyl) sebacate (Tinuvin® 770 from Ciba Specialty Chemicals, MW=481); bis-(1,2,2,6,6-pentamethyl-4-piperidinyl)-(3,5-ditert.butyl-4-hydroxybenzyl)butyl-propane dioate; bis-(1,2,2,6,6-pentamethyl-4-piperidinyl) sebacate; 8-acetyl-3-dodecyl-7,7,9,9-tetramethyl-1,3,8-triazaspiro-(4,5)-decane-2,4-dione, butanedioic acid-bis-(2,2,6,6-tetramethyl-4-piperidinyl) ester; tetrakis-(2,2,6,6-tetramethyl-4-piperidyl)-1,2,3,4-butane tetracarboxylate; 7-oxa-3,20-diazadispiro(5.1.11.2) heneicosan-20-propanoic acid, 2,2,4,4-tetramethyl-21-oxo, dodecyl ester; N-(2,2,6,6-tetramethyl-4-piperidinyl)-N′-amino-oxamide; o-t-amyl-o-(1,2,2,6,6-pentamethyl-4-piperidinyl)-monoperoxi-carbonate; β-alanine, N-(2,2,6,6-tetramethyl-4-piperidinyl), dodecylester; ethanediamide, N-(1-acetyl-2,2,6,6-tetramethylpiperidinyl)-N′-dodecyl; 3-dodecyl-1-(2,2,6,6-tetramethyl-4-piperidinyl)-pyrrolidin-2,5-dione; 3-dodecyl-1-(1,2,2,6,6-pentamethyl-4-piperidinyl)-pyrrolidin-2,5-dione; 3-dodecyl-1-(1-acetyl,2,2,6,6-tetramethyl-4-piperidinyl)-pyrrolidin-2,5-dione, (Sanduvar® 3058 from Clariant, MW=448.7); 4-benzoyloxy-2,2,6,6-tetramethylpiperidine; 1-[2-(3,5-di-tert-butyl-4-hydroxyphenylpropionyloxy)ethyl]-4-(3,5-di-tert-butyl-4-hydroxylphenyl propionyloxy)-2,2,6,6-tetramethyl-piperidine; 2-methyl-2-(2″,2″,6″,6″-tetramethyl-4″-piperidinylamino)-N-(2′,2′,6′,6′-tetra-methyl-4′-piperidinyl)propionylamide; 1,2-bis-(3,3,5,5-tetramethyl-2-oxo-piperazinyl) ethane; 4-oleoyloxy-2,2,6,6-tetramethylpiperidine; and combinations thereof. Other suitable low molecular weight hindered amines are described in U.S. Pat. No. 5,679,733 to Malik, et al.

The hindered amines may be employed singularly or in combination in any amount to achieve the desired properties, but typically constitute from about 0.01 wt. % to about 4 wt. % of the polymer composition.

UV absorbers, such as benzotriazoles or benzopheones, may be employed in the composition to absorb ultraviolet light energy. Suitable benzotriazoles may include, for instance, 2-(2-hydroxyphenyl)benzotriazoles, such as 2-(2-hydroxy-5-methylphenyl)benzotriazole; 2-(2-hydroxy-5-tert-octylphenyl)benzotriazole (Cyasorb® UV 5411 from Cytec); 2-(2-hydroxy-3,5-di-tert-butylphenyl)-5-chlorobenzo-triazole; 2-(2-hydroxy-3-tert-butyl-5-methylphenyl)-5-chlorobenzotriazole; 2-(2-hydroxy-3,5-dicumylphenyl)benzotriazole; 2,2′-methylenebis(4-tert-octyl-6-benzo-triazolylphenol); polyethylene glycol ester of 2-(2-hydroxy-3-tert-butyl-5-carboxyphenyl)benzotriazole; 2-[2-hydroxy-3-(2-acryloyloxyethyl)-5-methylphenyl]-benzotriazole; 2-[2-hydroxy-3-(2-methacryloyloxyethyl)-5-tert-butylphenyl]benzotriazole; 2-[2-hydroxy-3-(2-methacryloyloxyethyl)-5-tert-octylphenyl]benzotriazole; 2-[2-hydroxy-3-(2-methacryloyloxyethyl)-5-tert-butylphenyl]-5-chlorobenzotriazole; 2-[2-hydroxy-5-(2-methacryloyloxyethyl)phenyl]benzotriazole; 2-[2-hydroxy-3-tert-butyl-5-(2-methacryloyloxyethyl)phenyl]benzotriazole; 2-[2-hydroxy-3-tert-amyl-5-(2-methacryloyloxyethyl)phenyl]benzotriazole; 2-[2-hydroxy-3-tert-butyl-5-(3-methacryloyloxypropyl)phenyl]-5-chlorobenzotriazole; 2-[2-hydroxy-4-(2-methacryloyloxymethyl)phenyl]benzotriazole; 2-[2-hydroxy-4-(3-methacryloyloxy-2-hydroxypropyl)phenyl]benzotriazole; 2-[2-hydroxy-4-(3-methacryloyloxypropyl)phenyl]benzotriazole; and combinations thereof.

Exemplary benzophenone light stabilizers may likewise include 2-hydroxy-4-dodecyloxybenzophenone; 2,4-dihydroxybenzophenone; 2-(4-benzoyl-3-hydroxyphenoxy)ethyl acrylate (Cyasorb® UV 209 from Cytec); 2-hydroxy-4-n-octyloxy)benzophenone (Cyasorb®) 531 from Cytec); 2,2′-dihydroxy-4-(octyloxy)benzophenone (Cyasorb® UV 314 from Cytec); hexadecyl-3,5-bis-tert-butyl-4-hydroxybenzoate (Cyasorb® UV 2908 from Cytec); 2,2′-thiobis(4-tert-octylphenolato)-n-butylamine nickel (II) (Cyasorb® UV 1084 from Cytec); 3,5-di-tert-butyl-4-hydroxybenzoic acid, (2,4-di-tert-butylphenyl) ester (Cyasorb® 712 from Cytec); 4,4′-dimethoxy-2,2′-dihydroxybenzophenone (Cyasorb® UV 12 from Cytec); and combinations thereof.

When employed, UV absorbers may constitute from about 0.01 wt. % to about 4 wt. % of the entire polymer composition.

In one embodiment, the polymer composition may contain a blend of stabilizers that produce ultraviolet resistance and color stability. The combination of stabilizers may allow for products to be produced that have bright and fluorescent colors. In addition, bright colored products can be produced without experiencing significant color fading over time. In one embodiment, for instance, the polymer composition may contain a combination of a benzotriazole light stabilizer and a hindered amine light stabilizer, such as an oligomeric hindered amine.

In one embodiment, an amide wax may be present in the polymer composition. Amide waxes, for instance, may be employed that are formed by reaction of a fatty acid with a monoamine or diamine (e.g., ethylenediamine) having 2 to 18, especially 2 to 8, carbon atoms. For example, ethylenebisamide wax, which is formed by the amidization reaction of ethylene diamine and a fatty acid, may be employed. The fatty acid may be in the range from C₁₂ to C₃₀, such as from stearic acid (C₁₈ fatty acid) to form ethylenebisstearamide wax. Ethylenebisstearamide wax is commercially available from Lonza, Inc. under the designation Acrawax® C, which has a discrete melt temperature of 142° C. Other ethylenebisamides include the bisamides formed from lauric acid, palmitic acid, oleic acid, linoleic acid, linolenic acid, oleostearic acid, myristic acid and undecalinic acid. Still other suitable amide waxes are N-(2-hydroxyethyl) 12-hydroxystearamide and N,N′-(ethylene bis) 12-hydroxystearamide.

In addition to the above components, the polymer composition may include various other ingredients. Colorants that may be used include any desired inorganic pigments, such as titanium dioxide, ultramarine blue, cobalt blue, and other organic pigments and dyes, such as phthalocyanines, anthraquinones, and the like. Other colorants include carbon black or various other polymer-soluble dyes. The colorants can generally be present in the composition in an amount up to about 2 percent by weight.

### Polymer Articles

The compositions of the present disclosure can be compounded and formed into a polymer article using any technique known in the art. For instance, the respective composition can be intensively mixed to form a substantially homogeneous blend. The blend can be melt kneaded at an elevated temperature, such as a temperature that is higher than the melting point of the polymer utilized in the polymer composition but lower than the degradation temperature. Alternatively, the respective composition can be melted and mixed together in a conventional single or twin screw extruder. Preferably, the melt mixing is carried out at a temperature ranging from 150 to 300° C., such as from 200 to 280° C., such as from 220 to 270° C. or 240 to 260° C. However, such processing should be conducted for each respective composition at a desired temperature to minimize any polymer degradation.

After extrusion, the compositions may be formed into pellets. The pellets can be molded into polymer articles by techniques known in the art such as injection molding, thermoforming, blow molding, rotational molding and the like. According to the present disclosure, the polymer articles can demonstrate excellent tribological behavior and mechanical properties. Consequently, the polymer articles can be used for several applications where low wear and excellent gliding properties are desired.

Polymer articles include any moving articles or moldings that are in contact with another surface and may require high tribological requirements. For instance, polymer articles include articles for the automotive industry, especially housings, latches such as rotary latches, window winding systems, wiper systems, pulleys, sun roof systems, seat adjustments, levers, bushes, gears, gear boxes, claws, pivot housings, wiper arms, brackets or seat rail bearings, zippers, switches, cams, rollers or rolling guides, sliding elements or glides such as sliding plates, conveyor belt parts such as chain elements and links, castors, fasteners, levers, conveyor system wear strips and guard rails, medical devices such as medical inhalers, injection devices, surgical instruments, wearable devices and the like. An almost limitless variety of polymer articles may be formed from the polymer compositions of the present disclosure.

In one embodiment, the composition of the present disclosure is used to produce a first sliding member and a second sliding member. The first and second sliding members can both be made from a composition in accordance with the present disclosure. In particular, the first sliding member and the second sliding member can be made from a composition comprising a reinforced thermoplastic polymer in combination with one or more lubricants and an ultrahigh molecular weight silicone. The relative amounts of the components can be the same or can be different in each composition.

The first sliding member and the second sliding member can be contained in an apparatus and placed in operative association with each other such that the sliding members move relative to each other. For instance, in one embodiment, the first sliding member may be stationary while the second sliding member moves across the first sliding member. Alternatively, both sliding members may move while contacting each other.

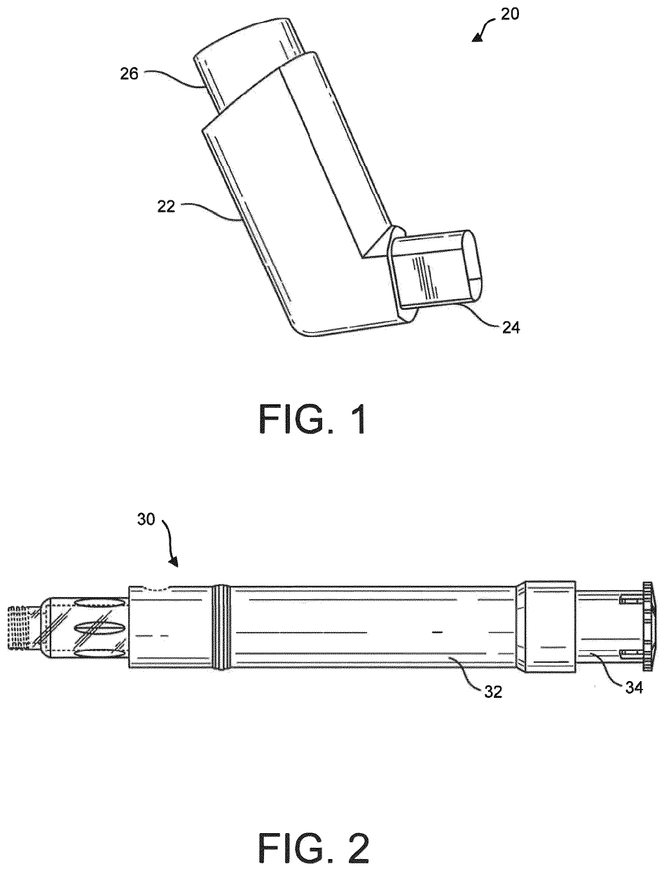

In one embodiment, the sliding members of the present disclosure can be used to produce a medical device. For instance, referring to FIG. 1, an inhaler 20 is shown. The inhaler 20 includes a housing 22 attached to a mouthpiece 24. In operative association with the housing 22 is a plunger 26 for receiving a canister containing a composition to be inhaled. The composition may comprise a spray or a powder. The inhaler 20 can include a first sliding member in operative association with a second sliding member. For instance, in certain embodiments, the housing 22 may comprise the first sliding member while the plunger 26 may comprise the second sliding member. Alternatively, the first sliding member may comprise the housing 22 and the second sliding member may comprise the mouthpiece 24. In still another embodiment, an internal sliding member may be contained within the housing 22 that slides relative to the housing.

During use, the inhaler 20 administers metered doses of a medication, such as an asthma medication to a patient. The asthma medication may be suspended or dissolved in a propellant or may be contained in a powder. When a patient actuates the inhaler to breathe in the medication, a valve opens allowing the medication to exit the mouthpiece.

In another embodiment of the present disclosure, the first sliding member and the second sliding member are contained in a medical injector 30 as shown in FIG. 2. The medical injector 30 includes a housing 32 in operative association with a plunger 34. The housing 32 or first sliding member may slide relative to the plunger 34 or second sliding member. The medical injector 30 may be spring loaded. The medical injector 30 is for injecting a drug into a patient, typically into the thigh or the buttocks. The medical injector can be needleless or may contain a needle. When containing a needle, the needle tip is typically shielded within the housing prior to injection. Needleless injectors, on the other hand, can contain a cylinder of pressurized gas that propels a medication through the skin without the use of a needle.

The polymer composition of the present disclosure is particularly well suited to constructing injectors as shown in FIG. 2, including syringes and autoinjectors, for dispensing high viscosity medicaments, such as biologics including protein-based pharmaceuticals. As high viscosity medicaments have become more prevalent in the pharmaceutical pipeline, the delivery devices face various significant challenges that high-viscosity drugs present to traditional autoinjectors. The injectors, for instance, are formed with greater injection forces so as not to necessitate a larger diameter needle that can result in increased pain for the patient. These forces can be stored in the device, usually as a compressed spring, prior to actuation.

The polymer composition is not only well suited to producing high pressure delivery devices, but also can contribute to sustainability by being reusable and capable of being exposed to sterilization radiation without losing mechanical properties or accuracy. In particular, molded articles made according to the present disclosure are resistant to wear and creep, even after multiple uses.

Creep, or cold flow, refers to the tendency of materials to slowly deform when held under high stress for extended periods of time. As such, creep can be an important consideration when designing injectors for biologics. In order to deliver these viscous formulations without increasing the size of the needle, these injectors require greater force to push the drug through the needle than is typically required. As such, greater force needs to be stored within the device prior to actuation, usually in the form of a compressed spring. This means that the device components are going to be under greater stress and therefore more susceptible to creep and the loss of some of that stored force, which can compromise device reliability. Molded articles made according to the present disclosure have enhanced creep properties and other properties that make the articles well suited for the above application.

For example, in addition to excellent creep resistance, the polymer composition of the present disclosure exhibits retention of elongation suitable for snap-fit assembly, high strength and stiffness, excellent suitability for gamma sterilization, high wear-resistance, low breakaway force, soundless sliding and elimination of stick-slip for improved patient comfort during delivery, good chemical resistance, and a smooth, appealing surface finish.

In one aspect, the polymer composition of the present disclosure is used to produce an injector, particularly an autoinjector, that is designed to dispense high viscosity fluids, such as biologics. The biologics, for instance, can have a relatively high molecular weight. The biologics, for example, can have an average molecular weight of greater than about 50 kDa, such as greater than about 75 kDa, such as greater than about 100 kDa, such as greater than about 125 kDa. The above biologics can be contained in a fluid that has a viscosity of greater than about 7 cP, such as greater than about 10 cP, such as greater than about 12 cP, such as greater than about 15 cP, such as greater than about 20 cP, such as greater than about 25 cP, such as greater than about 50 cP, such as greater than about 75 cP, such as greater than about 100 cP, such as greater than about 200 cP, such as greater than about 300 cP. The viscosity is generally less than about 1500 cP.

The injector can be designed to deliver a dose of fluid of greater than about 0.25 mL, such as greater than about 0.5 mL, such as greater than about 0.75 mL and generally less than about 5 mL, such as less than about 4 mL, such as less than about 3 mL. The injector can include a needle having a bore size of generally greater than about 0.08 mm, such as greater than about 0.1 mm, such as greater than about 0.12 mm, such as greater than about 0.14 mm, such as greater than about 0.16 mm, and generally less than about 0.3 mm, such as less than about 0.25 mm, such as less than about 0.22 mm, such as less than about 0.2 mm.

The injector can be designed to inject a fluid, such as a biologic, subcutaneously at a maximum force that is generally greater than about 2 N. The maximum force is the highest force before all contents are extruded from the injector. The maximum force can be greater than about 3 N, such as greater than about 4 N, such as greater than about 5 N, such as greater than about 6 N, such as greater than about 7 N, such as greater than about 8 N, such as greater than about 10 N, such as greater than about 12 N. The maximum force is generally less than about 20 N. The pressure at which the fluid is emitted from the injector can generally be greater than about 100 mPa, such as greater than about 150 mPa, such as greater than about 175 mPa, such as greater than about 200 mPa, such as greater than about 225 mPa, such as greater than about 250 mPa, such certain about 275 mPa, such as greater than about 300 mPa, such as greater than about 325 mPa and generally less than about 1,000 mPa.

### Properties

The present disclosure is particularly directed to a polymer composition that can be used to make molded parts such that when the parts slide against each other excessive wear and/or noise generation is inhibited and even eliminated.

For example, in one embodiment, the present disclosure is directed to a low friction assembly that includes a first sliding member in operative association with a second sliding member. The first sliding member and the second sliding member can both be made from a polymer composition formulated in accordance with the present disclosure. When tested against each other, the composition can be formulated so as to exhibit a dynamic coefficient of friction of less than about 0.08, such as less than about 0.07, such as less than about 0.06, such as less than about 0.05, such as less than about 0.04, such as less than about 0.03, such as less than about 0.02, such as less than about 0.01. The compositions or molded parts can be tested against each other according to a stick-slip test having Test No. VDA 230-206.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A polymer composition comprising:
a polyester polymer, the polyester polymer comprising a polybutylene terephthalate polymer, one or more polyester polymers being present in the polymer composition in an amount greater than about 70% by weight;
a tribological modifier comprising a silicone polymer blended with a polyethylene polymer;
at least one lubricant; and
wherein the polymer composition is free of glass fibers.

2. A polymer composition as defined in claim 1, wherein the tribological modifier is present in the polymer composition in an amount from about 0.1% by weight to about 10% by weight.

3. A polymer composition as defined in claim 1, wherein the silicone polymer contained in the tribological modifier comprises an ultrahigh molecular weight silicone polymer having a kinematic viscosity of greater than about 100,000 mm²s⁻¹.

4. A polymer composition as defined in claim 1, wherein the silicone polymer contained in the tribological modifier comprises a polydimethylsiloxane polymer.

5. A polymer composition as defined in claim 1, wherein the polyethylene polymer contained in the tribological modifier comprises a low density polyethylene polymer.

6. A polymer composition as defined in claim 1, wherein the silicone polymer is present in the tribological modifier in relation to the polyethylene polymer at a weight ratio of from about 3:1 to about 1:3.

7. A polymer composition as defined in claim 1, wherein the polymer composition further contains a nucleating agent.

8. A polymer composition as defined in claim 7, wherein the nucleating agent comprises a mineral nucleant.

9. A polymer composition as defined in claim 1, wherein the lubricant comprises an oxidized polyolefin wax or a polyolefin polymer modified by maleic anhydride groups.

10. A polymer composition as defined in claim 1, wherein the lubricant comprises an oxidized polyethylene wax.

11. A polymer composition as defined in claim 1, wherein the lubricant comprises a polymer having an acid value of from about 10 KOH/g to about 25 KOH/g.

12. A polymer composition as defined in claim 1, wherein the lubricant comprises a polymer having an acid value of from about 30 KOH/g to about 75 KOH/g.

13. A polymer composition as defined in claim 1, wherein the lubricant comprises a polyethylene wax.

14. A polymer composition as defined in claim 1, wherein the lubricant comprises oxidized esters of fatty acids.

15. A polymer composition as defined in claim 14, wherein the oxidized esters of fatty acids are formed from at least 50% by weight of fatty acids having a carbon chain length of from about 20 carbon atoms to about 40 carbon atoms.

16. A polymer composition as defined in claim 14, wherein the oxidized esters of fatty acids are formed from at least 25% by weight of fatty acids having a carbon chain length of from about 40 carbon atoms to about 64 carbon atoms.

17. A polymer composition as defined in claim 1, wherein the lubricant comprises a mixture of a first polymer lubricant and a second polymer lubricant, the first polymer lubricant comprising an oxidized polyethylene wax, a polyolefin polymer modified by maleic anhydride groups, or oxidized esters of fatty acids, the second polymer lubricant comprising a non-polar polyethylene wax and
wherein each lubricant is present in the polymer composition in an amount less than about 2% by weight, such as in an amount less than about 0.3% by weight, and in an amount greater than about 0.01% by weight.

18. A molded article made from the polymer composition as defined in claim 1.

19. A molded article as defined in claim 18, wherein the molded article comprises an injector, the injector for dispensing liquid medicaments, the injector including a needle that has a bore size of from about 0.08 mm to about 0.25 mm, the injector including a spring member that dispenses doses of a medicament at a maximum force of greater than about 3 N.

20. A molded article as defined in claim 18, wherein the molded article comprises an inhaler, an injection device, a surgical instrument, or a wearable device.
